(19) United States
(12) Patent Application Publication
(10) Pub. No.: US 2019/0335905 A1
(43) Pub. Date: Nov. 7, 2019

(54) BACK SUPPORTING APPARATUS, CHAIR AND METHOD OF USING THE SAME

(71) Applicant: Mark Alexander, Victoria (AU)

(72) Inventor: Mark Alexander, Victoria (AU)

(21) Appl. No.: 16/309,628

(22) PCT Filed: Jun. 21, 2017
(86) PCT No.: PCT/IB2017/053703

§ 371 Date: Dec. 13, 2018

Related U.S. Application Data
(60) Provisional application No. 62/353,004, filed on Jun. 21, 2016.

(51) Int. Cl. A47C 7/42; B60N 2/66; A47C 7/46; A61H 15/00

(52) U.S. Cl. CPC A47C 7/425; B60N 2/663; B64D 11/0647; A61H 15/00; A47C 7/46

(57) ABSTRACT

A spine support apparatus for dynamic stabilization of a user's spine is provided. The apparatus an elongated base positioned in a sagittal plane; a plurality of variable spine support elements coupled to the base and spaced apart from one another to define a spine receiver to stabilize the user's spine, the spine support elements having a first spherical transverse protrusion; and a second spherical transverse protrusion spaced apart on its coronal plane by a valley, the valley being configured to receive any one of a neck vertebrae, a thoracic spine, or a lumbar spine; wherein the plurality of variable spine support elements are dimensioned with varying thickness on their transverse plane to correspond with the user's lordotic curve. A chair utilizing the apparatus and method of use are also provided herein.

### CROSS-REFERENCE TO RELATED APPLICATION

The present utility patent application claims the priority benefit of PCT application No. PCT/IB2017/053703 entitled Back Supporting Apparatus, Chair and Method of Suing the Same filed Jun. 21, 2017 which claims the benefit of the U.S. provisional patent application Ser. No. 62/353,004 filed on Jun. 22, 2016, entitled Back Supporting Apparatus and Method the entirety of each of which are incorporated herein by reference for all purposes.

### FIELD OF THE INVENTION

The present invention relates generally to a back-supporting apparatus, back-supporting chair, and method of using the same. More particularly, the invention relates to a back-supporting apparatus that improves posture and reduces deleterious forces applied to the spine.

### BACKGROUND OF THE INVENTION

Many members of the population suffer from back problems. One cause of the back problems experienced by such people are the chairs used particularly during work and recreation activities, such as office chairs at work for extended periods or when relaxing at home in poorly supporting chairs, such as lounge chairs. In the past, almost all chairs have had back portions that are concave to the user, meaning that the chair back forms a curve or cup in which the central area or portion is dished or forms a concave curve when compared to the sides of the back of the chair, such that the back of the person occupying the chair resting in the concave shape of the back of the chair has a tendency to adopt a corresponding concave curved shape in which the shoulders tend to be in a rounded position extending slightly forward of the chest cavity of the person; this is not a position that is conducive to maintaining a good posture. The problem with using chairs having a generally concaved shaped back is that their use tends to make the person occupying the chair to slump or slouch forward and not sit upright. Slouching places the passive structures of the thoracic spine such as ligaments, discs, muscles, and nerves in a stretch or in a more or less continually stretched position In addition, it also places the passive structures of the lumbar spine such as the discs in a compressed position. Continual stretching of the thoracic spine and compressing the lumbar spine such as this can lead to pain and injury. In particular, the longer a person sits in a slouched position, the longer and larger are the forces placed upon the spine, which in turn results in there being a greater tendency for pain to develop in the spine. This force, over time, stretches the passive structures of the thoracic spine, and compresses the lumbar spine, which in turn, leads to the development of back pain.

Another way of describing the shortcomings of existing chairs relates to the structure and architecture of the spine and the problems which cause painful conditions in the spine. In healthy individuals, or at least in individuals with good posture, the lumbar spine, the lower back, has a curve or is curved inwardly, which is referred to as the lordotic curve or lordosis. When conventional chairs with concave backs are used, there is a tendency for the lower back of the person using such chairs to lose lordosis, which leads to abnormal deleterious forces being applied to the spine and allows the onset of conditions in the back which develop pain, damage, and injury.

Furthermore, existing support devices lack true portability, and more importantly, the ability to attach to multiple chairs or other objects, and to be easily and effortlessly changed over from chair to chair.

Therefore, there is a need for an apparatus and chair that addresses the problems caused by slumping or slouching when seated in a chair using the methods currently available.

There is also a need for a therapeutic device that reverses the effects of prolonged sitting and slouching. By lying on a device that arches the back in an extended position, this reverses a deleterious slouched position and can assist to relieve back pain.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a perspective view of the back-support apparatus in accordance with an embodiment of the present invention;

FIG. 2 is a top view of the back-supporting elements of the back-support apparatus in accordance with embodiment of the present invention;

FIG. 3 is a perspective view of the exemplary types of spine-supporting elements in accordance with an embodiment of the present invention;

FIG. 4 is a side view perspective view of the back-supporting device with the spine-supporting elements therein in accordance with an embodiment of the present invention;

FIG. 5 is a perspective view of a portion of the fastener of the back-supporting device without the back-supporting elements therein in accordance with an embodiment of the present invention;

FIG. 6 is a perspective view of another portion of the fastener of the back-supporting device without the back-supporting elements therein in accordance with an embodiment of the present invention;

FIG. 7 is a perspective view of another portion of the fastener of the back-supporting device without the back-supporting elements therein in accordance with an embodiment of the present invention;

FIG. 8 is an exploded view of the fastener of the back-supporting device without the back-supporting elements therein in accordance with an embodiment of the present invention;

FIG. 9a is a perspective view of a chair having a back-support apparatus in accordance with an embodiment of the present invention;

FIG. 9b is a perspective view of a seat such as a car seat having a back-supporting apparatus attached thereto in accordance with an embodiment of the present invention;

FIG. 10 is a step-wise method diagram in accordance with an embodiment of the present invention;

Unless otherwise indicated illustrations in the figures are not necessarily drawn to scale.

### SUMMARY OF THE INVENTION

To achieve the forgoing and other aspects, and in accordance with the purpose of the invention, a support apparatus for the spine is presented.

In one embodiment, a spine support apparatus for dynamic stabilization of a user's spine is provided. The apparatus comprises an elongated base positioned in a sagittal plane; a plurality of variable spine support elements coupled to the base and spaced apart from one another to define a spine receiver to stabilize the user's spine, the spine support elements comprising a first spherical transverse protrusion; and a second spherical transverse protrusion spaced apart on its coronal plane by a valley, the valley being configured to receive any one of a neck vertebrae, a thoracic spine, or a lumbar spine; wherein the plurality of variable spine support elements are dimensioned with varying thickness on their transverse plane to correspond with the user's lordotic curve.

In another embodiment, a chair having a backrest is provided. The chair comprises a plurality of variable spine support elements coupled to the backrest and spaced apart from one another to define a spine receiver to stabilize the user's spine, the spine support elements comprising a first spherical transverse protrusion; and a second spherical transverse protrusion spaced apart on its coronal plane by a valley, the valley being configured to receive any one of a neck vertebrae, a thoracic spine, or a lumbar spine; wherein the plurality of variable spine support elements are dimensioned with varying thickness on their transverse plane to correspond with the user's lordotic curve.

In another embodiment a method for supporting the spine of seated user is provided. The method comprises attaching an elongated base to a backrest of a chair, the elongated base being positioned in a sagittal plane; wherein the elongated base comprises a plurality of variable spine support elements coupled to the base and spaced apart from one another to define a spine receiver to stabilize the user's spine, the spine support elements comprising a first spherical transverse protrusion; and a second spherical transverse protrusion spaced apart on its coronal plane by a valley, the valley being configured to receive any one of a neck vertebrae, a thoracic spine, or a lumbar spine; wherein the plurality of variable spine support elements are dimensioned with varying thickness on their transverse plane to correspond with the user's lordotic curve.

Advantageously, it is an aim of the present invention to provide a back supporting structure for use with a chair, which is configured so to address the problem of back pain developing in the user of the chair caused by slumping and/or slouching.

Advantageously, the support apparatus described herein is optimally portable and is easily transferable from chair to chair, strapped to a car seat, an airline seat, and a train seat, or may be easily built in to a chair, and also placed on the floor to act as a therapeutic treatment device.

Advantageously, the support apparatus described herein comprises different types of replaceable back supporting members to ensure optimal comfort for the user.

Advantageously, the support apparatus is universal in nature and adjusts to the sagittal length of the user.

Advantageously, the forces applied to the spine and muscles by the support apparatus relieve back pain and stiffness, reduce muscle tension and trigger points, and relieve headaches, as per a therapeutic treatment from a health professional such as a Physical Therapist, Osteopath, Chiropractor, Massage Therapist.

The described arrangement has been advanced by explanation and many modifications may be made without departing from the spirit and scope of the invention, which includes every novel feature and novel combination of features herein disclosed.

Other features, advantages, and aspects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed, but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, apparatuses, and materials are described, although any methods, techniques, apparatuses, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

As used herein, “back-supporting apparatus” and “spine-supporting apparatus” are used interchangeably.

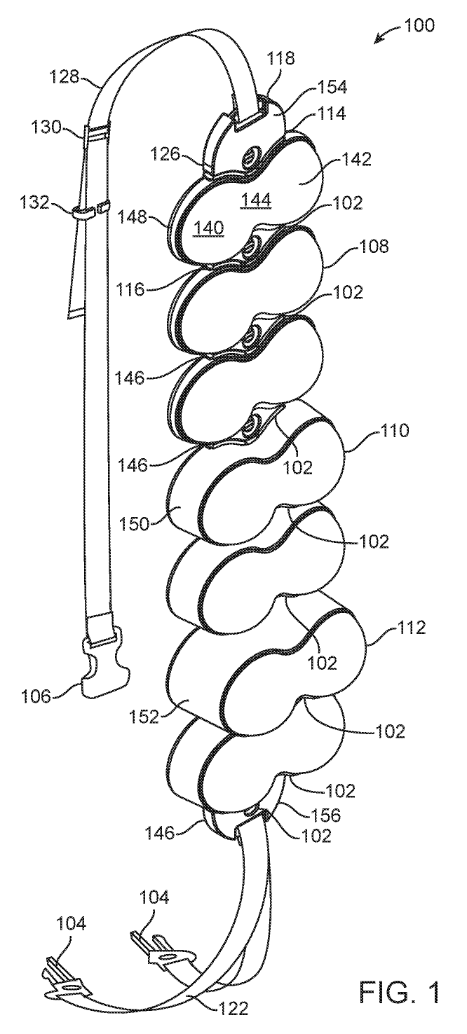

Referring now to FIG. 1, a spine support apparatus for dynamic stabilization of a user's spine is provided generally at 100. The apparatus comprises an elongated base 102, a male clip 104, a female clip 106, a plurality of variable spine or back supporting elements 108, 110, and 112 (n+1), superior strap 128, and inferior straps 122.

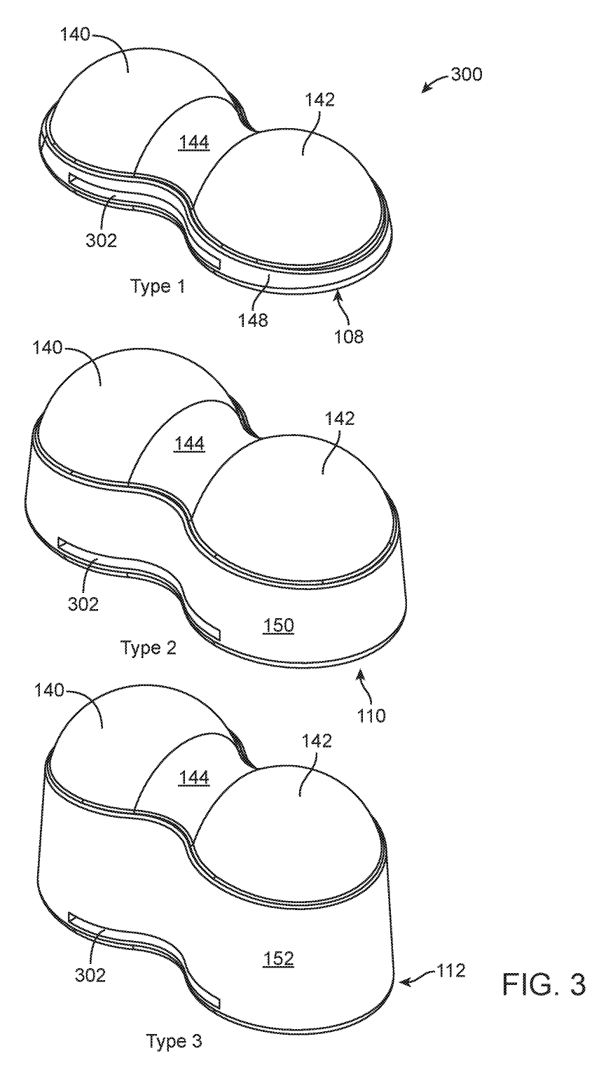

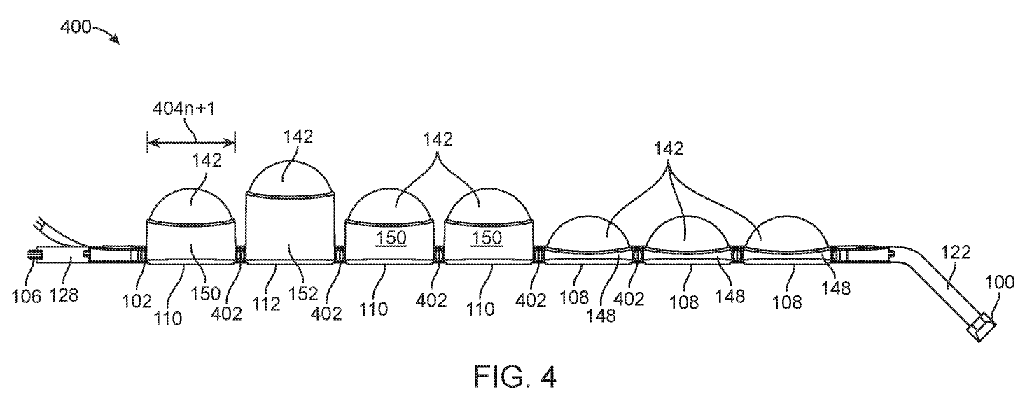

In exemplary embodiments of the present invention, the base 102 is formed of injection molded ultraviolet stabilized nylon, but may be formed of any suitable, flexible and resilient material. The base 102 may be a single unitary unit, or in optional embodiments, may comprise multiple units or segments 146 that are connectable via interference fit, snap fit, or any known connection conduit, discussed in greater detail with relation to FIGS. 3 and 4. The units or segments may comprise ribs (shown in FIG. 3) that are integrally molded on each side and attach each segment to the next, each of which are formed to engage the next segment 146. In optional embodiments, the apparatus is a unitary one piece arrangements, such that the base 102 is overmolded within an injection molded tool to become one unit together with the back-supporting elements 108, 110, and 112.

In operation, the base 102 is positioned on the user's sagittal plane, and is shaped and dimensioned to provide stability when it is coupled to an object, such as a chair. By sagittal plane it is mean that that it is positioned up and down, or longitudinally. The width the base 102 should be wide enough to avoid over-rotation should the user move, but thin enough to move with the user should the user make slight movements in his or her chair or seat. The shape of each segment, as shown, is approximately in the shape of a super-ellipse, but may be square, or in some e embodiments, the base 102 may be a single unitary body.

With reference still to FIG. 1, the spine-supporting and stabilization apparatus 100 comprises variable spine supporting elements 108, 110 and 112. The variable spine supporting elements 108, 110 and 112 comprise a first spherical transverse protrusion 140, a second spherical transverse protrusions 142, and a valley 144 therebetween. Each the first and second spherical transverse protrusions 140 and 142 are spaced apart by the valley 144, the valley 144 being configured to receive any one of a neck vertebrae, a thoracic spine, or a lumbar spine. The variable spine supporting elements 108, 110 and 112 are configured to support certain section of the spine together with the ancillary musculature attached or coupled thereto, discussed in greater detail with relation to FIG. 3. As an example, the spherical transverse portions may contact muscles such as the erector spinae or the thoracolumbar fascia, while the valley provides a resting place for the spine, keeping the user in an upright optimal lordodic position.

It should be noted that while spherical or semi-spherical protrusions are shown, other protrusions such as ridges with less curvature are in the purview of the present invention.

As can be seen in FIG. 1, the plurality of variable spine support elements 108, 110 and 112 are dimensioned with varying thickness on their transverse plane to correspond with the user's lordotic curve. In this way, as mentioned previously, the spine supporting elements may be of different types. The types of members are defined by the thickness or height of the pedestals 148, 150, and 152 of the supporting elements 108, 110 and 112, respectively, which are of a predetermined thickness. As can be seen in FIG. 1, the back supporting element 108 is of a first type in which the pedestal is thin, approximately 35 centimeters. Back supporting element 110 is of a second type in which the pedestal is relatively thicker, approximately 55 centimeters. The back supporting element 112 is of a third type in which the pedestal is still relatively thicker than both back-supporting element 108 and back-supporting element 110 at approximately 75 mm. Each back supporting element 108, 110 and 112 has a different thickness in a transverse direction in relation to the user, and in operation, due to the spherical protrusions 140 and 142 (together with valley 144), are diametrically opposed to the spinal S-shaped curve, in which the low back (lumbar) region has a slight concave curve, and the thoracic and sacral regions have a gentle convex curve. While only three types of backs supporting members having different heights are shown in FIG. 1, many different heights and types of back supporting members are contemplated and in the purview of the present invention. The configuration, from top to bottom along the base of type 1, type 1, type 2, type 2, type 3, type 2, is only one possible configuration of many user configurable configurations that are in the purview of the present invention. Depending upon the spinal length of the user, more or less types of spinal support members may be employed by the user, because in operation, the base can be extended or contracted and back supporting members can be replaced with other types of back supporting members depending on the shape of the user and the shape of the chair, until the user is optimally comfortable, and the spine is optimally supported. In other words, the spine support elements are configured to make direct contact with an erector spinae muscles on either side of, or adjacent to, the spine of the user, while applying pressure to a rib angle of the user thereby maintaining an upright position so that the back of the user is pushed up and out to adopt a more correct anatomical position, maintaining lordosis of the lower back and preventing slouching of the thoracic spine.

Referring still to FIG. 1, the apparatus comprises an inferior strap 122 coupled to the elongated base on its superior end 154, a female clip 106 connected to the end of the strap 128, and a second v-shaped strap 122 coupled to the elongated base on its inferior end 156 and having dual male clips 104, which are configured to both mate with the female clip 106. The straps are adjustable via adjustable slide member 130. A hook 132 is provided to harness slack. Like the base 102, the female clip 106 may be formed of injection molded ultraviolet stabilized nylon. In operation, the female clip 106 is configured coupled to the superior end of the base via the first strap 122. The inferior strap 122 may comprise two straps formed in a V-array, the end of each strap comprising their own male clips 104. In optional embodiments, the design allows for the two straps to bifurcate around the bases of chairs as a single strap to increase the ease of connectivity to a plurality of chair designs. Optionally, the bottom strap may be a single strap having its own male buckle, or optionally, a plurality of straps employed to further stabilize the base to the object it is attached to (e.g., back of a chair).

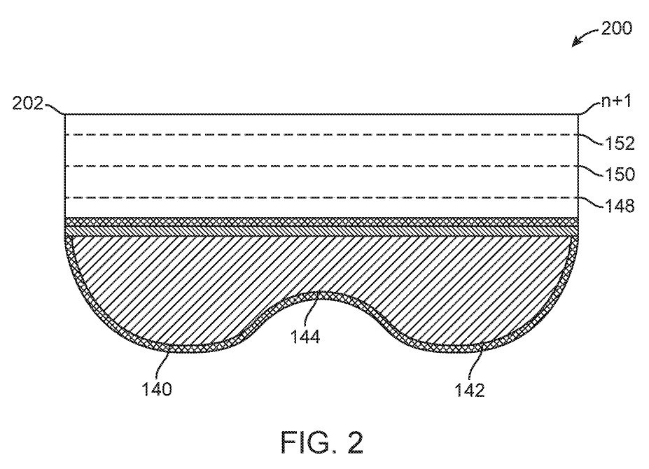

Referring now to FIG. 2, a top view of the back-supporting member is shown generally at 200. Spherical transverse protrusion 140 and 142 and valley 144 are shown herein. These portions face the user's spine and the valley 144 allows the protruding spinous process of the user's spine to not uncomfortably contact the apparatus. As represented by the dashed lines on the full pedestal 202, the plurality of types of pedestals 148, 150, and 152 are shown each having different thicknesses. That is, if one were to cut away the upper portion of the member at the dashed lines, one would arrive at the height of the variable spine supporting elements that is desirable for each of back supporting member type 1 108, type 2 110, and type 3 112, and so on (n+1). It should be noted that while these shapes of each back supporting member are approximately congruent, the dimensions may differ accordingly, and that the drawings are not shown to scale.

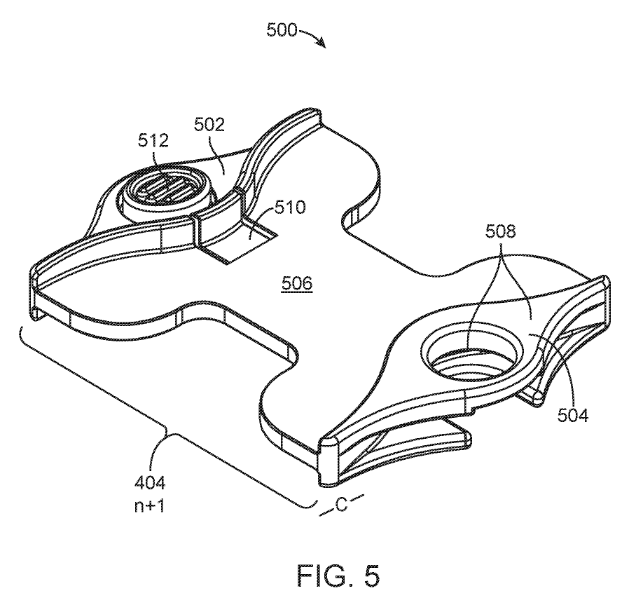

Referring now to FIG. 3, a perspective view of the spine-supporting members of each type are shown are shown generally at 300. As shown a clear image of the transverse protrusions 140 and 142 and valley 144 are shown herein. The pedestals 148, 150, and 152 comprise an orifice 302 which is configured to accept a portion of the adjacent segments that form the elongated base 102, which will be discussed in more detail with relation to FIGS. 5-8. It should be noted that while the shapes of each back supporting element 108 are approximately congruent, the dimensions may differ accordingly, and that the drawings are not shown to scale, and that while spherical sections are shown, ridges may be employed as well.

Referring now to FIG. 4, a side view of an optional embodiment of the present invention is shown generally at 400. For purposes of orientation, the elongated base 102 is shown with variable spine supporting elements 108, 110 and 112, a first spherical transverse protrusion 140, a second spherical transverse portion 142, and a valley 144 therebetween. The pedestals 148, 150, and 152 are shown as well. In this embodiment, rather than being a single unitary structure, the base 102 is segmented (a segment being shown at 404n+1), some segments having the spine-supporting members 110, 112, and 114 connected thereon on a top surface, other segments comprising mating sections that have snap fit joints with male and female portions, each of which are dimensioned to receive any of the plurality of segments 404n+1. The variable spine supporting elements 108, 110, and 112 formed thereon may be unitary and molded via tooling, or may be transferable and replaceable by the user. Furthermore, the base 102, shown in its segmented form in which units or segments are connected by snap fit joints 402, shown more clearly in FIGS. 5-7, allowing the user to shorten or lengthen the base 102 to fit his or her spine. Optionally, rather than snap fit elements, the segments may be connected using interference fit, friction fit, hook and loop fasteners, magnets, screws, toggles, and the like.

Referring now to FIG. 5 a perspective view of a portion of the snap fit fastener of the back-supporting device without the back-supporting elements therein is shown generally at 500. The snap fit fastener 500 is used to attach flexible parts, usually plastic, to form the final based and back supporting apparatus by pushing the parts' interlocking components together, in this case, male portion 502 and female portion 504 of the adjacent segment 404n+1. While as shown, a cantilever snap fit is employed, it should be noted that torsional and annular snap fits may be used as well. Using this snap fit, the segments may be slid inside the adjacent segment to engage the other.

The male portion 502 of the snap fit fastener 500 comprises a clip 506 and cantilever snap 510, and the female portion 504 comprises aperture 508. The cantilever snap 510 is formed on a first end of the clip 506, and forms a portion of the segment itself while the aperture 508 is extruding from a second end of the clip, opposite the first end of the clip 506.

Once adjacent an additional segment 404n+1, the segments may be coupled together by inserting the male portion 502 of the snap fit fastener 500 into the female portion 504 thereby forming part of the base 102. In operation, the cantilever snap 510 is flexible in nature but like a leaf spring has force that pushes outwardly. Thus, a user depresses the button 512 on the cantaliever snap 510, inserts the male portion 502, and releases the button 512 which extends through the aperture of the adjacent segment 404n+1. The amount of deflection experienced by the present cantilever snap for a fixed load may be varied by varying the length of the cantilever snap, varying the location of the load with respect to the end of the cantilever snap, and by varying the material properties of the cantilever snap. Several variations of the above-mentioned characteristics may be performed by the present system and method. According to one exemplary embodiment, the present cantilever snap is made of plastic, having a favorable modulus of elasticity.

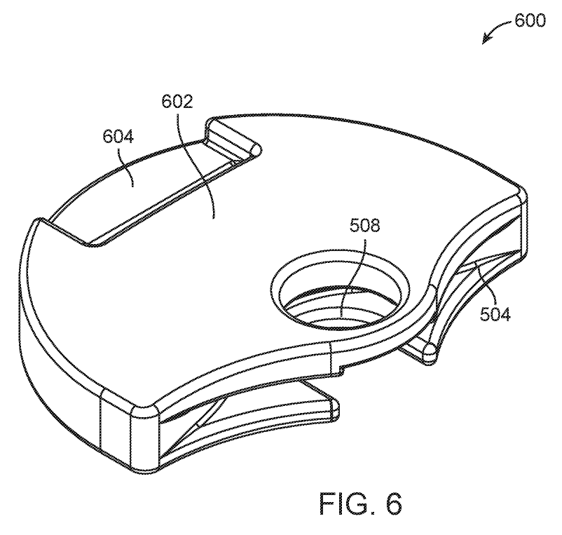

With reference now to FIG. 6, the female portion 504 of the clip 506 on the snap fit fastener 500 is shown generally at 600. The female portion 504 comprises a housing 604 and joinder element 606, which comprises a strap attachment. The aperture 508 can be seen as well. The housing 604 has in internal section defining a space for the male portion 502 to couple with the segment to provide additional stability. Joinder element 606 is provided on the opposite side of the housing for additional stability once the segments are mated and to provide a strap attachment.

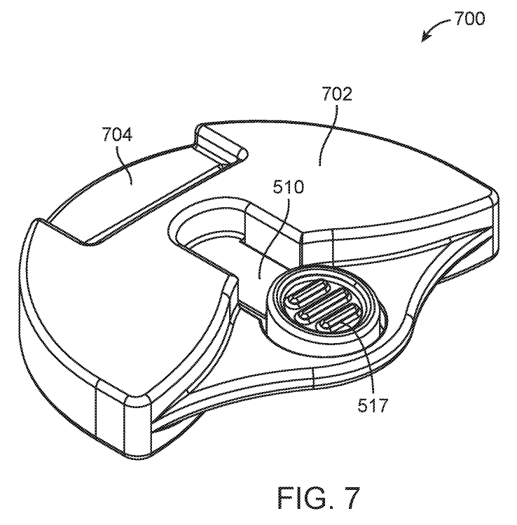

With reference now to FIG. 7, the male portion 502 of the clip 506 on the snap fit fastener 500 is shown generally at 700. The male portion 502 comprises housing 702, and joinder element 704. The cantilever snap 510 is shown attached to the cantilever 704, which provides force in the upward direction due to the modulas of elasticity of the material it is formed of. The housing 604 has in internal section defining a space for the female portion 504 to couple with the segment to provide additional stability. Joinder element 704 is provided on the opposite side of the housing for additional stability once the segments are mated as well and to provide s snap attachment.

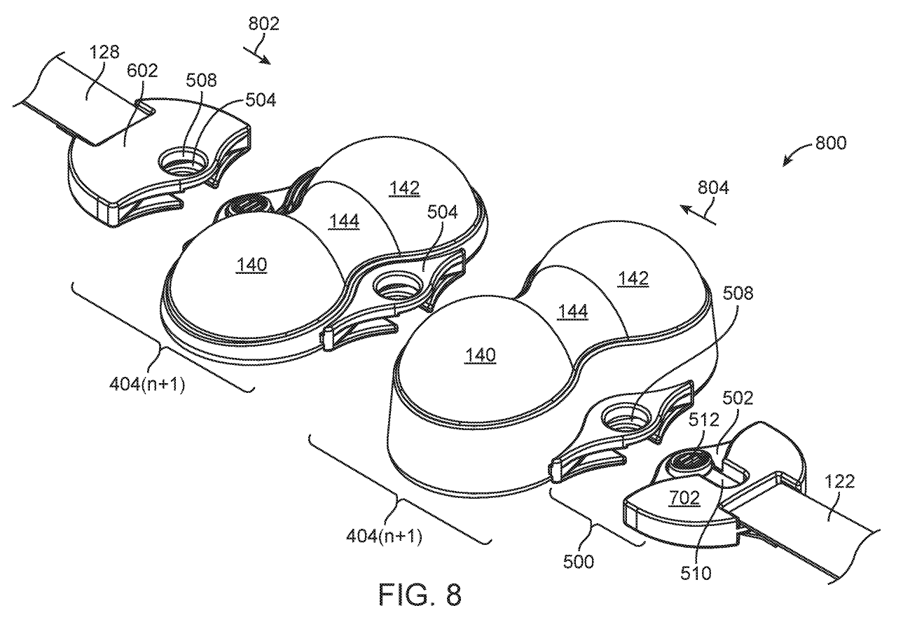

With reference now to FIG. 8, an exploded perspective view of the back-supporting device is shown generally at 800. This view shows the operation of the adjacent segments 404n+1 coupling via the snap fit fastener 500 in the directions of arrow 802 and arrow 804. The adjacent segment 404n+1, the segments may be coupled together by inserting male portion 502 of the snap fit fastener 500 into the female portion 504 thereby forming part of the base 102. In operation, the cantilever snap 510 is depressed by the user, and the male portion 502 is inserted into the female portion 504.

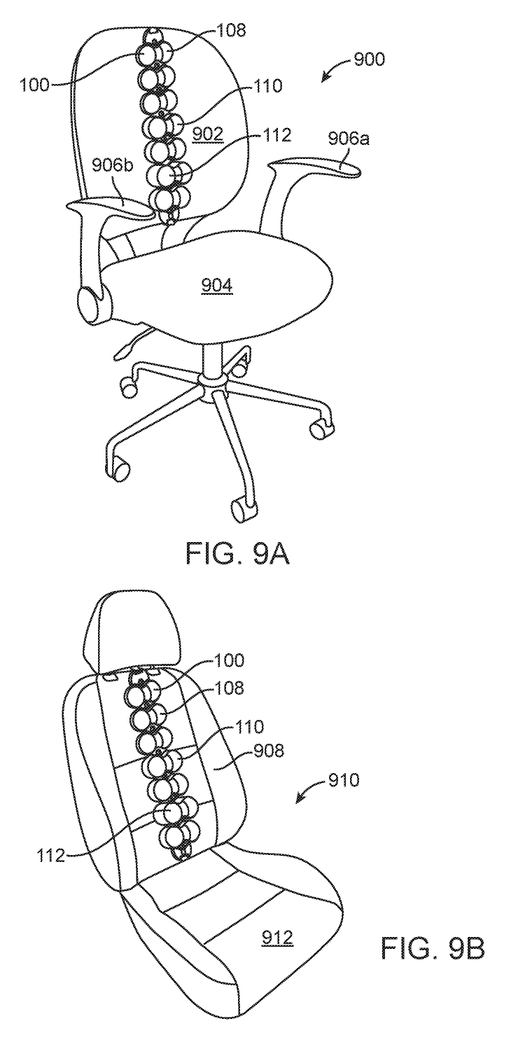

Referring now to FIG. 9a, one form of a chair, generally denoted as 900 is shown. The chair 900 comprises a back portion 902, a seat portion 904, and two opposed rails 906a and 906b on either side of the chair. Although one form of the chair is illustrated in the drawings, chair 900 can have any suitable or convenient form, and includes chairs having an adjustable back, a tilting chair, reclining chair, or the like.

The back portion 902 of chair 900 comprises back supporting elements 108, 110, 112 and (n+1), fixedly attached thereto in the configuration of type 1, type 1, type 2, type 2, type 3, type 2, however, other configurations are contemplated as well.

Referring now to FIG. 9b, configurations are contemplated and in the purview of the present invention, one form of a car seat chair, generally denoted as 910 is shown. The chair 900 comprises a car seat back portion 908, a car seat portion 910. The back supporting elements 108, 110, 112 and (n+1), strapped thereto in the configuration of type 1, type 1, type 2, type 2, type 3, type 2, however, other configurations are contemplated as well.

In optional embodiments, the back supporting members are integral and formed within the chair themselves. In other optional embodiments, the back-supporting members are clipped in and removable and replaceable as an insert. Yet in other optional embodiments, the apparatus of FIG. 1, spine support apparatus 100 may be clipped to the back of the chair using the straps as shown in FIG. 1.

In operation, owing to the spherical portions facing parts of each back supporting element, when a person sits in chair with their spine centrally located within valley regions, the presence of bulbous portions forms a generally convex curved shape. When a person rests against the forwardly facing surface of the chair back, the back of the person is forced into a generally upright position by the back supporting members contacting the erector spinae muscles on either side or adjacent to the spine, and apply pressure to the rib angles of the person maintaining an upright position so that the back of the person is pushed up and out so as to adopt a more correct anatomical position thereby maintaining lordosis of the lower back and preventing slouching of the thoracic spine, and minimizing the chances that pain could develop due to poor posture by slumping, slouching, or the like.

In optional embodiments, in operation, should the device be used on the flow on the floor as a therapeutic device, owing to the bulbous upwardly facing parts of each back supporting element, when a person lies on the floor with their spine centrally located within valley regions the presence of bulbous portions forms a generally convex curved shape of the spine. When a person lies on the upwardly facing surface of the device, the back of the person is forced into a generally extended position by the back supporting members contacting the erector spinae muscles on either side or adjacent to the spine, and apply pressure to the rib angles of the person maintaining an upright position so that the back of the person is pushed up and out so as to adopt a more extended anatomical position thereby increasing the lordosis of the lower back and thoracic spine, and reversing the effects of poor posture by slumping, slouching, or the like and increasing the chances that pain could be relieved.

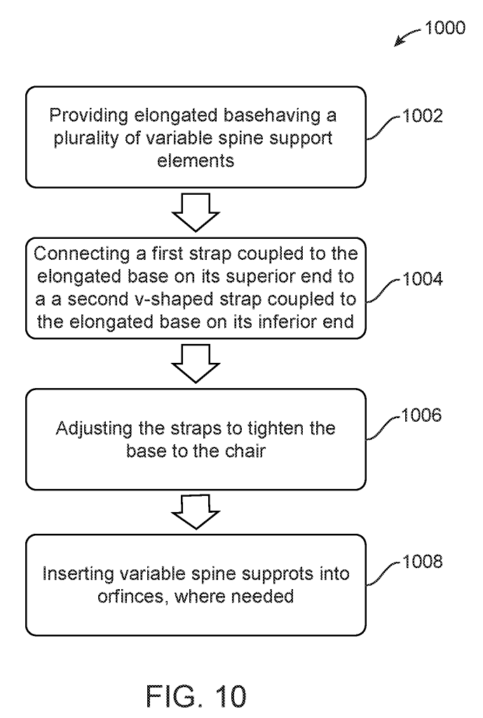

Referring now to FIG. 10, there is a flow chart illustrating a method for attaching a back-supporting apparatus to a chair generally at 1000. While the flowchart shows an exemplary step-by-step method, it is to be appreciated that a skilled artisan may rearrange or reorder the steps while maintaining like results.

Providing elongated base having a plurality of variable spine support elements step 1002 comprises providing a base with a plurality of variable spine support elements coupled to the base and spaced apart from one another to define a spine receiver to stabilize the user's spine, the spine support elements comprising a first spherical transverse protrusion, and a second spherical transverse protrusion spaced apart by a valley, the valley being configured to receive any one of a neck vertebrae, a thoracic spine, or a lumbar spine, wherein the plurality of variable spine support elements are dimensioned with varying thickness on their transverse plane to correspond with the user's lordotic curve such as that shown in FIG. 1.

Connecting a first strap coupled to the elongated base on its superior end to a second v-shaped strap coupled to the elongated base on its inferior end, step 1004 comprises using the straps to connect the apparatus to a chair to provide a snug fit.

Adjusting the traps to tighten the base to the chair, step 1006 comprises using the slides to tighten the base to the chair.

Inserting variable spine supports where needed, step 1008 comprises a user inserting segments having the proper support for their lordotic curve.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

Although specific features of various embodiments of the invention may be shown in some drawings and not in others, this is for convenience only. In accordance with the principles of the invention, the feature(s) of one drawing may be combined with any or all of the features in any of the other drawings. The words “including”, “comprising”, “having”, and “with”, as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

We claim:

1. A spine support apparatus for dynamic stabilization of a user's spine, the apparatus comprising:
an elongated base positioned on a sagittal plane with relation to the user;
a plurality of variable spine support elements coupled to the base and spaced apart from one another to define a spine receiver to stabilize the user's spine, the spine support elements comprising:
a first spherical transverse protrusion; and
a second spherical transverse protrusion spaced apart from the first spherical transverse protrusion by a valley, the valley being configured to receive any one of a neck vertebra, a thoracic spine, or a lumbar spine;
wherein the plurality of variable spine support elements are dimensioned with varying thickness on their transverse plane to correspond with the user's lordotic curve.

2. The apparatus of claim 1, wherein the apparatus is connectable to a chair via at least one strap.

3. The apparatus of claim 1, wherein the elongated base comprises a plurality of segments that are attachable and detachable to each other to allow a user to lengthen or shorten the base, each of the segments comprising a mating section.

4. The apparatus of claim 3, wherein the mating sections comprise snap fit joints having male and female portions, each of which are dimensioned to receive any of the plurality of segments, wherein at least one of the segments is coupled with variable spine-supporting element on its top side such that a user is able to switch out a spine supporting element of a first type for a spine supporting element of a different type.

5. The apparatus of claim 2, wherein the at least on strap comprise a first strap coupled to the elongated base on its superior end and having a male clip, and a second v-shaped strap coupled to the elongated base on its inferior end and having a female clip, the straps being adjustable, and configured for attachment to the chair.

6. The apparatus of claim 5, wherein the apparatus is a single unitary structure that is injection molded, and the strap is a single strap that runs through a series of orifices in the elongated base.

7. The apparatus of claim 1, wherein the plurality of variable spine support elements comprise a pedestal, the pedestal defining a type of at least two types of a the spine support elements, the types comprising:
a first type having a pedestal that is of a first predetermined thickness;
a second type having a pedestal that is of a second predetermined thickness;
a third type having a pedestal that is a third predetermined thickness;
wherein the pedestal comprises an orifice for mating to the base, or is molded to each of the segments;
wherein starting from the superior end of the elongated base to the inferior end of the elongated base, the types are configured to support the lordodic curve of the user.

8. The apparatus of claim 7, wherein in a one configuration, starting from the superior end of the elongated base to the inferior end of the elongated base, there are three first types in a row, followed by two second types, followed by a single third type, followed by a single second type.

9. The apparatus of claim 1, wherein spine support elements are configured to make direct contact with an erector spinae muscles on either side or adjacent to the spine of the user, and apply pressure to a rib angle of the user thereby maintaining an upright position such that the back of the user is pushed up and out to adopt a more correct anatomical position, maintaining lordosis of the lower back and preventing slouching of the thoracic spine.

10. A chair having at least a backrest, the chair comprising:
a plurality of variable spine support elements coupled to the backrest and spaced apart from one another to define a spine receiver to stabilize the user's spine, the spine support elements comprising:
a first spherical transverse protrusion; and
a second spherical transverse protrusion spaced apart from the first spherical transverse protrusion plane by a valley, the valley being configured to receive any one of a neck vertebra, a thoracic spine, or a lumbar spine;
wherein the plurality of variable spine support elements are dimensioned with varying thickness on their transverse plane to correspond with the user's lordotic curve.

11. The chair of claim 10, wherein the chair comprises a plurality of orifices configured to receive the plurality of spine support elements, the orifices being spaced apart on the sagittal plane.

12. The chair of claim 10, wherein the orifices are dimensioned to receive any of the plurality of variable spine supporting elements such that a user is able to switch out a spine supporting element of a first type for s spine supporting element of a different type, the orifices and spine supporting elements being coupled.

13. The chair of claim 10, wherein the chair and the spine elements is a single unitary structure integrated with the backrest and is injection molded.

14. The chair of claim 10, wherein the plurality of variable spine support elements comprises a pedestal, the pedestal defining a type of at least two types of a the spine support elements, the types comprising:
a first type having a pedestal that is of a first predetermined thickness;
a second type having a pedestal that is of a second predetermined thickness;
a third type having a pedestal that is a third predetermined thickness;
wherein, starting from the superior end of the elongated base to the inferior end of the chair, the types are configured to support the lordodic curve of the user.

15. The chair of claim 10, wherein starting from the superior end of the chair to an inferior end of the chair, there are three first types in a row, followed by two second types, followed by a single third type, followed by a single second type.

16. The chair of claim 10, wherein spine support elements are configured to make direct contact with an erector spinae muscles on either side or adjacent to the spine of the user, and apply pressure to a rib angle of the user thereby maintaining an upright position so that the back of the user is pushed up and out to adopt a more correct anatomical position thereby maintaining lordosis of the lower back and preventing slouching of the thoracic spine.

17. A method for supporting the spine of seated user, the method comprising:
attaching an elongated base to a backrest of a chair, the elongated base being positioned in a sagittal plane;
wherein the elongated base comprises a plurality of variable spine support elements coupled to the base and spaced apart from one another to define a spine receiver to stabilize the user's spine, the spine support elements comprising:
a first spherical transverse protrusion; and
a second spherical transverse protrusion spaced apart on its coronal plane by a valley, the valley being configured to receive any one of a neck vertebra, a thoracic spine, or a lumbar spine;
wherein the plurality of variable spine support elements are dimensioned with varying thickness on their transverse plane to correspond with the user's lordotic curve.

18. The method of claim 17, wherein attaching the elongated base to a backrest of a chair comprises connecting a first strap coupled to the elongated base on its superior end to a second v-shaped strap coupled to the elongated base on its inferior end.

19. The method of claim 17, further comprising adjusting the straps to tighten the base to the chair.

20. The method of claim 17, wherein the plurality of variable spine support elements comprises a pedestal, the pedestal defining a type of at least two types of the spine support elements, the types comprising:
a first type having a pedestal that is of a first predetermined thickness;
a second type having a pedestal that is of a second predetermined thickness;
a third type having a pedestal that is a third predetermined thickness;
wherein, starting from the superior end of the elongated base to the inferior end of the elongated base, the types being configured to support the lordotic curve of the user.
